(19) United States
(12) Patent Application Publication
(10) Pub. No.: US 2012/0210880 A1
(43) Pub. Date: Aug. 23, 2012

(54) DISPOSABLE DEVICE FOR MAKING BEVERAGES FROM SOLUBLE PRODUCTS

(76) Inventor: Viktor Kolesnyk, Brooklyn, NY (US)

(21) Appl. No.: 13/032,648

(22) Filed: Feb. 23, 2011

(51) Int. Cl. A47J 31/06

(52) U.S. Cl. 99/298

(57) ABSTRACT

A disposable device for making beverages from extractable products comprises a cup, a filter partition mounted on the inner wall of the cup separating the useful volume in the cup into an upper compartment and a lower compartment, and extractable products inside the lower compartment. The extractable products include but are not limited to tea leaves and ground coffee beans. The filter partition stops the tea leave residues and coffee bean residues from entering the upper compartment while allowing the extracted soluble material to flow through the filter into the upper compartment for drinking without being bothered by residual tea leaves or coffee grounds. The device is easy, convenient, quick to use, low cost to manufacture, and safe to carry.

### BACKGROUND OF THE INVENTION

1. Field of the Invention

The present invention relates generally to a disposable device for making beverages from extractable, soluble products, and more particularly, to a device comprising a cup, a filter partition separating the useful volume in the cup into an upper compartment and a lower compartment, and extractable products inside the lower compartment.

2. Description of Related Art

U.S. PreGrant Pub. No. 20060045936 to Shen (2006) discloses a cup for user to directly drink the beverage in the cup. The cup comprises a main body and an isolating member disposed in the main body for dividing the interior of the cup into two isolated spaces and stopping the beverage material, while permitting the beverage to flow through the isolating member (membrane) from one isolated space to the other. The isolating member (membrane) is removable to allow the beverage materials to be put in by anyone especially the drinker.

U.S. PreGrant Pub. No. 20050279220 (2005) to Cheng discloses a cup and filter combination comprising a foldable filter inside the cup. The combination further comprises a foldable retaining ring for holding the filter within the cup. To prepare a cup of tea, a tea drinker pulls open the retaining ring and place tealeaves in the filter, and pours hot water into the filter to brew tea. After brewing the tea, the tea drinker pulls the retaining ring back to the folded configuration with the residual tealeaves remaining in the filter.

Although both aforementioned inventions offer a tea drinker options to choose the tea leaves and quantity of tea leaves, the procedures are tedious and are not suitable for use in a public setting, such as in a conference, a meeting, a party or in an office where the drinkers normally just want to have an easy and convenient access to a drink without going through tedious procedures.

U.S. Pat. No. 5,842,408 to Hatta (1998) discloses a portable package unit used for extraction of coffee including a filter assembly that can be attached to a receptacle such as a cup. The filter assembly comprises a filter and a foldable funnel. The invention suffers from the drawback that it is expensive to manufacture as the foldable funnel frame forms a body separate from the outer bag, and thereby complicating the manufacturing process. Moreover, the invention is not suitable for drinkers who just want to have a quick access to drinks in public settings.

U.S. Pat. No. 7,793,585 to Rasmussen et al. (2010) discloses a disposable brewing device and WO 2007025541 to Rasmussen et al. (2007) discloses a disposable filtering cup comprising at least one filter arrangement, wherein said filtering cup is at least partly formed by joined sheet material. The procedure for preparing beverages includes opening the device, adding aroma material, adding hot water which is tedious. Both devices made of joined sheet material need to be carefully handled with hot water inside.

U.S. Pat. No. 7,437,990 to Duch (2008) discloses an all-in-one beverage container for providing a mixed beverage product. The container includes a stem for enabling axial movement of the percolating mechanism. The shortcoming of the device is that when the user drinks from the cup the stem will get in the way.

U.S. Pat. No. 6,038,963 to Patterson et al. (2000) discloses a disposable filter press device for making a brewed beverage from a combination of liquid and material to be brewed including a first disposable cup and a second disposable cup. The device suffers from the drawback that it has two disposable cups which lead to an unnecessarily higher manufacturing cost and environmental contamination.

### SUMMARY OF THE INVENTION

The primary object of the present invention is to provide a device for making beverages from extractable products, tea leaves and ground coffee in particular, that is simple, convenient and quick to use, low cost to manufacture, easy and safe to carry. The invention disclosed in the present application overcomes the tedious procedures and drawbacks encountered in the aforementioned patents and pre-Grant publications.

The present invention relates to a disposable device for making beverages from extractable products; said device comprises a container in the form of a cup having an inner wall, an exterior wall, and a bottom wall; a partition made of filter material mounted on the inner wall of the container in parallel to the bottom of the container to separate the useful volume in the container into an upper compartment and a lower compartment; and an extractable product placed within the lower compartment for brewing or extraction. The extractable product may be tea leaves and ground coffee beans, instant coffee. The extractable product may be other flavoring materials such as dried flowers or dried fruits or any soluble drinking supplements.

Because the cup already contains tea leaves or ground coffee beans or instant coffee or other flavoring materials, a user only needs to add water (or other liquids) to the cup and let it brew/infuse for a while to extract the soluble material from the extractable products; it is easy, convenient and quick to use in a public setting, such as in a conference, a meeting, a party, or an office, etc. The partition is made of paper filter or silk filter to prevent the tea leave residues or coffee bean residues from entering the upper compartment, while allowing the extracted soluble material to diffuse/flow through filter into the upper compartment where the extract is further diluted by water. The user can directly drink the beverage in the cup without removing the filter partition or the tea leaves or coffee beans residues. The partition filter may be made of other material suitable for food packaging.

The container may be made of disposable materials including food cardboard and plastic material such as homopolymer or copolymer of ethylene or propylene. In the preferred embodiment of the invention, the container is made of food cardboard. The container may be further coated with liquid-impermeable material and/or heat-resistant polymer if necessary. The container may further comprise a lid for protecting the beverage from spilling while walking. The partition filter is made of paper or silk that is commonly used in tea bags or coffee filters. The partition filter may be fastened to the inner wall of the container by food glues. The partition filter may further have a heat-sealable thermoplastic such as PVC or polypropylene, as a component fiber so it can be welded or thermo adhesively attached onto the inner wall of the container.

During manufacturing of the device, after an extractable product is put inside the space close to the bottom of the container, the outer edge of the partition is permanently fastened to the circumference of the inner wall of the container by food glue or by thermo adhesive or by welding and thus separate the useful volume of the container into an upper compartment and a lower compartment wherein the extractable product is placed.

The lower compartment is about 20%-30% of the useful volume of the container. In the preferred embodiment, the lower compartment is preferably about 10%-15% of the useful volume of the cup. The lower compartment is only partially filled with extractable products to allow the extractable products to unfold and expand once soaked/brewed in the water or other liquids.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a side view of an embodiment according to the present invention

FIG. 2 is a cross-sectional view taken along the vertical median plane of the embodiment disclosed in FIG. 1.

FIG. 3 is a cross-sectional view taken along the median plane of the embodiment disclosed in FIG. 1 after the water is added to the cup.

FIG. 4 is a top view of the embodiment disclosed in FIG. 1.

FIG. 5 is a bottom view of the embodiment disclosed in FIG. 1.

### DESCRIPTION OF THE PREFERRED EMBODIMENT

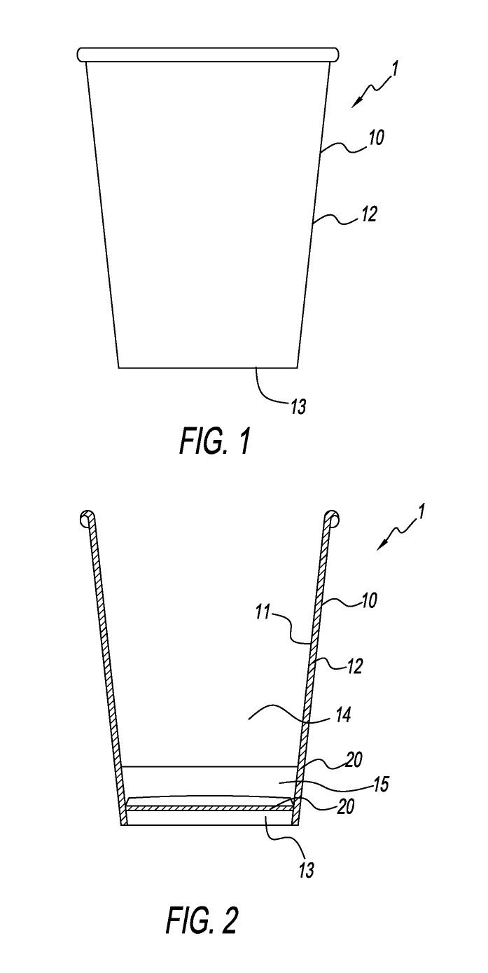

Referring to FIG. 1, there is disclosed a side view of an embodiment according to the present invention and FIG. 2 there is disclosed a cross-sectional view taken along the vertical median plane of the embodiment disclosed in FIG. 1. The preferred embodiment of the present invention 1 comprises a container in the form of a cup 10 having an inner wall 11 (not shown in FIG. 1), an exterior wall 12, and a bottom 13; a partition 20 made of filter material and mounted on the inner wall 11 of the cup 10 separating the useful volume of the cup 10 into an upper compartment 14 and a lower compartment 15; and an extractable product 30 placed within the lower compartment 15.

In the preferred embodiment of the invention, the lower compartment 15 is about 10%-15% of the useful volume of the cup 10. The lower compartment 15 is only partially filled with extractable products 30 to allow the extractable products 30 such as tea leaves, ground coffee beans to unfold or expand once soaked/brewed in water or other liquids. The cup 10 may be made of disposable material including food cardboard, plastic material such as homopolymer or copolymer of ethylene or propylene. In the preferred embodiment of the invention, the cup 10 is made of food cardboard and the partition filter 20 is made of paper or silk that is commonly used in tea bags or coffee filters. The partition filter 20 is fastened to the inner wall 11 of the cup 10 by food glues. The partition filter may further have a heat-sealable thermoplastic such as PVC or polypropylene, as a component fiber so it can be welded (thermo adhesively mounted) onto the inner wall 11 of the cup 10. The cup 10 may further comprise a lid for protecting the beverage from spilling while walking.

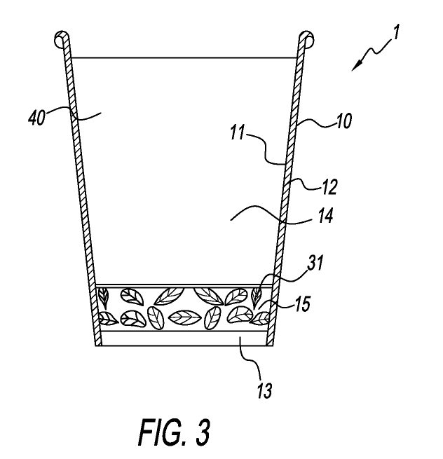

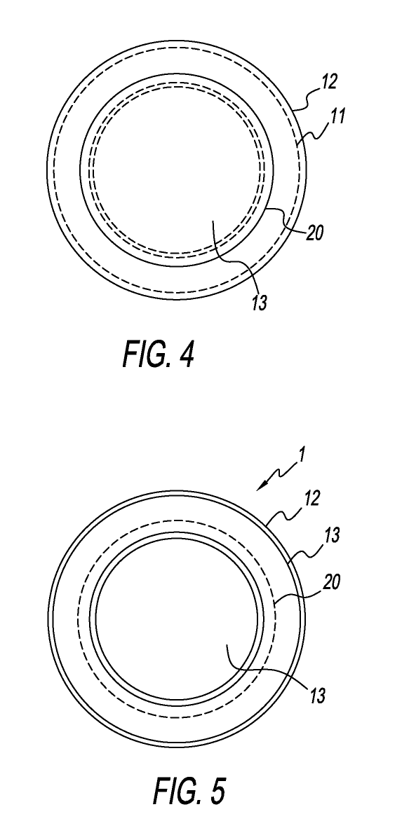

FIG. 3 is a cross-sectional view taken along the vertical median plane of the embodiment disclosed in FIG. 1 after the water (or other liquid) is added to the cup. The extractable product 30 such as tea leaves soaked, unfolded and expanded in water. If the tea leaves are not refrained by a partition 20, the tea leaf residues floating up to the surface of the beverage 40 will make drinking difficult. A filter partition 20 mounted on the inner wall 11 keeps the tea leaf residues 31 from entering the upper compartment 14 while allowing the extracted soluble material to flow through the filter 20 and into the upper compartment 14 for drinking without being bothered by the residual tea leaves 31. FIG. 4 and FIG. 5 show a top view and a bottom view respectively of the embodiment disclosed in FIG. 1.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A disposable device for making beverages from extractable products comprising:
a. a container in the form of a cup having an inner wall, an exterior wall and a bottom;
b. a partition made of filter material mounted on the inner wall of the container in parallel to the bottom surface of the container to separate the useful volume in the container into an upper compartment and a lower compartment; and
c. an extractable product placed within the lower compartment.

2. The disposable device for making beverages from extractable products of claim 1, wherein the lower compartment is about 10%-15% of the useful volume in the container.

3. The disposable device for making beverages from extractable products of claim 1, wherein the lower compartment is about 20%-30% of the useful volume in the container.

4. The disposable device for making beverages from extractable products of claim 1, wherein the container is made of a food cardboard.

5. The disposable device for making beverages from extractable products of claim 1, wherein the container is made of plastic material suitable for use on food products.

6. The disposable device for making beverages from extractable products of claim 1, wherein the container is made of at least one of homopolymer and copolymer of ethylene or propylene.

7. The disposable device for making beverages from extractable products of claim 1, wherein the partition filter may be made of paper.

8. The disposable device for making beverages from extractable products of claim 1, wherein the partition filter may be made of silk.

9. The disposable device for making beverages from extractable products of claim 1, wherein the outer edge of the partition is attached to the inner circumference of the container by food glue.

10. The disposable device for making beverages from extractable products of claim 1, wherein the outer edge of the partition is attached to the inner circumference of the container by thermal adhesive or welding.

11. The disposable device for making beverages from extractable products of claim 1, wherein the extractable product may be at least one of tea leaves, coffee grounds, and other food products.

12. The disposable device for making beverages from extractable products of claim 1, wherein the cup may be further coated with heat-resistant polymer.

13. The disposable device for making beverages from extractable products of claim 1, wherein the cup further comprises a lid.

14. A disposable device for making beverages from extractable products comprising:
a. a container in the form of a cup having an inner wall, an exterior wall, a bottom and a lid;
b. a partition made of filter material mounted on the inner wall of the container in parallel to the bottom surface of the container to separate the useful volume in the container into an upper compartment and a lower compartment;
c. an extractable product placed within the lower compartment; and wherein the lower compartment is about 10%-15% of the useful volume in the cup, the cup is made of food cardboard, the partition filter is made of paper or silk, the outer edge of partition filter is permanently fastened to the conference of the inner wall by food glue, welding or thermo adhesive.

15. A disposable device for making beverages from extractable products comprising:
a. a container in the form of a cup having an inner wall, an exterior wall, a bottom and a lid;
b. a partition made of filter material mounted on the inner wall of the container in parallel to the bottom surface of the container to separate the useful volume in the container into an upper compartment and a lower compartment;
c. an extractable product placed within the lower compartment; and wherein the lower compartment is about 20%-30% of the useful volume in the cup, the cup is made of food cardboard, the partition filter is made of paper or silk, the outer edge of partition filter is permanently fastened to the conference of the inner wall by food glue, welding or thermo adhesive.
